(19) United States
(12) Patent Application Publication
(10) Pub. No.: US 2015/0372961 A1
(43) Pub. Date: Dec. 24, 2015

(54) NOTIFICATION GENERATION SYSTEM FOR MESSAGES

(71) Applicant: International Business Machines Corporation, Armonk, NY (US)

(72) Inventors: Maggie H. Phung, Austin, TX (US); Johnny M. Shieh, Austin, TX (US); Chin Ngai Sze, Austin, TX (US); Zhennan Wang, Austin, TX (US)

(21) Appl. No.: 14/309,169

(22) Filed: Jun. 19, 2014

(51) Int. Cl. H04L 12/58; G06F 3/0481

(52) U.S. Cl. CPC H04L 51/24; G06F 3/0481

(57) ABSTRACT

A method for generating a notification about a recipient of a message. The recipient of the message is identified while the message is being composed. Whether information is present about the recipient for use in composing the message is determined. The notification is presented to the sender based on the information identified about the recipient while the message is being composed when the information about the recipient is present for the message.

### BACKGROUND

1. Field

The disclosure relates generally to an improved data processing system and, in particular, to messages. Still more particularly, the present disclosure relates to a method and apparatus for generating notifications about recipients of messages.

2. Description of the Related Art

The Internet is commonly used for many purposes. The Internet is often used to search for information on websites. People and organizations communicate with each other over the Internet.

For example, people may send invites to meetings, send and receive emails, and exchange chat messages. With communications, such as emails and invites to meetings, lists of recipients may be used to send emails and invites to multiple people.

One drawback to compiling a list of recipients for an email or an invite is that the sender often may need to recall information about some of the recipients. For example, a recipient may be unable to receive attachments or attachments over a certain size. Another recipient may be unable to receive attachments of a particular type or that have a selected extension. For example, the recipient may be unable receive executable files. As another example, another recipient may tend to not attend meetings to which they are invited. In still yet another example, a recipient may have more than one email address but only checks one address on a regular basis.

These examples are ones that illustrate some of the difficulties in sending emails and invites to multiple recipients. As the number of recipients or potential recipients increase, taking into account information such as these and other preferences of recipients or limitations. Therefore, it would be desirable to have a method and apparatus that takes into account at least some of the issues discussed above, as well as other possible issues.

### SUMMARY

In one illustrative embodiment, a method, data processing system, and computer program product for generating a notification about a recipient of a message is disclosed. A data processing system identifies the recipient of the message while the message is being composed. The data processing system determines whether information is present about the recipient for use in composing the message. The data processing system the presents the notification to the sender based on the information identified about the recipient while the message is being composed when the information about the recipient is present for the message.

### BRIEF DESCRIPTION OF THE SEVERAL VIEWS OF THE DRAWINGS

FIG. 1 is an illustration of a block diagram of a messaging environment in accordance with an illustrative embodiment;

FIG. 2 is an illustration of a block diagram of an example of information in a database in accordance with an illustrative embodiment;

FIG. 3 is an illustration of a block diagram of another example of information in a database in accordance with an illustrative embodiment;

FIG. 4 is an illustration of a block diagram of a user interface for a message application in accordance with an illustrative embodiment;

FIG. 5 is an illustration of an example of a notification to a sender for a recipient of a message in accordance with an illustrative embodiment;

FIG. 6 is an illustration of an example of notifications to a sender for recipients of a message in accordance with an illustrative embodiment;

FIG. 7 is an illustration of a flowchart of a process for generating a notification about a recipient of a message in accordance with an illustrative embodiment;

FIG. 8 is an illustration of a flowchart of a process for determining whether information is present about a recipient of a message for use in composing the message in accordance with an illustrative embodiment;

FIG. 9 is an illustration of a flowchart of a process for managing messages in accordance with an illustrative embodiment; and

FIG. 10 is an illustration of a block diagram of a data processing system in accordance with an illustrative embodiment.

### DETAILED DESCRIPTION

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described below with reference to flowchart illustrations and/or block diagrams of methods, apparatuses (systems) and computer program products according to embodiments of the invention. It will be understood that each block of the flowchart illustrations and/or block diagrams, and combinations of blocks in the flowchart illustrations and/or block diagrams, can be implemented by computer readable program instructions.

These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowcharts and block diagrams in the Figures illustrate the architecture, functionality, and operation of possible implementations of systems, methods, and computer program products according to various embodiments of the present invention. In this regard, each block in the flowcharts or block diagrams may represent a module, a segment, or a portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, can be implemented by special purpose hardware-based systems that perform the specified functions or acts or carry out combinations of special purpose hardware and computer instructions.

The illustrative embodiments recognize and take into account a number of different considerations. For example, the illustrative embodiments recognize and take into account that many factors may be from individual observations of the sender of a message. In other words, some information may be known by the sender based on the relationship between the recipient and the sender of the message.

The illustrative embodiments also recognize and take into account that some of the information about a recipient may be information about the recipient that the recipient may wish to remain undisclosed. The sender, however, may know of this information based on the relationship with the recipient while others may not know of this type of information.

For example, a recipient may publish when they are out of the office on a calendar, but may not wish to publish that they are unavailable for video conferences between 1:00 pm and 3:00 pm. This information about availability for conference times is undisclosed information.

In another illustrative example, the recipient may be unable to receive attachments on a regular basis because the recipient is often over the mailbox size limit. This information may not be generally known. The sender, however, may know of this situation because of the relationship with the recipient.

Therefore, the illustrative embodiments provide a computer implemented method, a computer system, and a computer program product for generating a notification about a recipient of a message. In one illustrative example, the recipient of the message is identified while the message is being composed. A determination is made as to whether information for use in composing the message is present about the recipient. A notification is presented to the sender based on the information identified about the recipient while the message is being composed when the information about the recipient is present for the message.

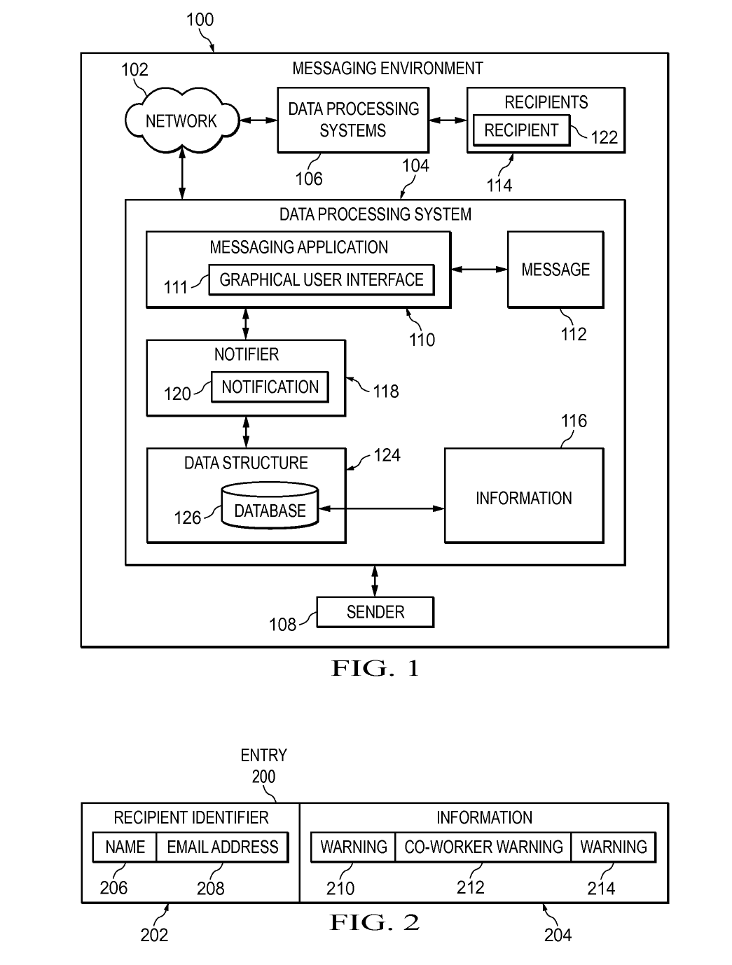

With reference now to the figures in particular with reference to FIG. 1, an illustration of a block diagram of a messaging environment is depicted in accordance with an illustrative embodiment. For example, messaging environment 100 includes network 102. Network 102 may be used to carry information such as messages. Network 102 may take various forms. For example, network 102 may be at least one of a local area network, a wide area network, the Internet, or some other suitable type of network.

As used herein, the phrase “at least one of,” when used with a list of items, means different combinations of one or more of the listed items may be used and only one of each item in the list may be needed. In other words, at least one of means any combination of items and number of items may be used from the list but not all of the items in the list are required. The item may be a particular object, thing, or a category.

For example, without limitation, “at least one of item A, item B, or item C” may include item A, item A and item B, or item B. This example also may include item A, item B, and item C or item B and item C. Of course, any combinations of these items may be present. In other examples, “at least one of” may be, for example, without limitation, two of item A; one of item B; and ten of item C; four of item B and seven of item C; or other suitable combinations.

In this illustrative example, data processing system 104 is connected to network 102. Data processing system 104 may connect to network 102 through a number different mechanisms. For example, data processing system 104 may connect using at least one of a wire cable, an optical cable, an wireless connection, or some other suitable type of mechanism.

In this illustrative example, data processing system 104 may communicate with data processing systems 106. As depicted, data processing systems 106 also are connected to network 102. In this illustrative example, data processing system 104 and data processing systems 106 may take various forms. One of the data processing systems may be, for example, a computer, a tablet computer, a laptop computer, a mobile phone, or some other suitable type of data processing system.

In the illustrative example, sender 108 is a person that may use message application 110 on data processing system 104. In particular, sender 108 may interact with graphical user interface 111 for message application 110 to compose message 112 to send to a group of recipients in recipients 114 at a group of data processing systems 106. A “group of,” as used herein with reference to items, means one or more items. For example, a group of recipients 114 is one or more of recipients 114.

As depicted, message application 110 is a software application that may take various forms. For example, message application 110 may be selected from one of an email application, a calendar program, a chat program, an instant messaging application, or some other suitable type of software that may be used to compose messages. In this illustrative example, message 112 may be, for example, an email message, a meeting invite, or some other suitable type of message.

Composing message 112 includes the different steps involved in sending message 112. For example, composing message 112 may include entering content of message 112, changing portions of content of message 112, removing portions of content of message 112, selecting a group of recipients 114, spell checking, adding attachments, and other suitable steps that occur prior to sending message 112. As used herein, content of a message is information that may take a form selected from at least one of text, images, video, graphics, audio, program code, a script, or other information that may be placed into the message. For example, content of a message may be entered into at least one of a subject line of the message, a body of the message, or other suitable portions of a message. Portions of the content of the message may be formatted for later processing. For example, a portion of the content of message 112 may include a meeting invitation a format suitable for processing by a calendaring program.

In this illustrative example, while composing message 112, sender 108 selects the group of recipients 114 to receive message 112. In this case, sender 108 may need to remember information 116 about some or all of the group of recipients 114. For example, one of the group of recipients 114 may be unable to receive attachments over a particular size. Another recipient in the group of recipients 114 may have a tendency to not attend meetings to which they are invited.

In another illustrative example, two or more of the group of recipients 114 should not all receive message 112. For example, having two or more of the group of recipients 114 at the same meeting may result in the disruption of the meeting from past experiences. As another example, disagreements may be present between one or more of recipients 114 with respect to commenting to an email message. Thus, those recipients should not all receive message 112 for more efficient commenting on message 112.

In this illustrative example, information 116 is known to sender 108 through the relationship of sender 108 with some or all of recipients 114. For example, the relationship of sender 108 with some or all the recipients 114 may allow for observations of sender 108 that identify information 116. In other words, information 116 may be based on what sender 108 knows about recipients from dealings or interactions with recipients. As depicted, information 116 may be information that sender 108 knows but may wish to remain undisclosed but also is helpful in composing message 112.

As depicted, notifier 118 is located in data processing system 104 and is implemented as a software component, hardware, or some combination thereof. Notifier 118 identifies information 116 for the group of recipients 114. Information 116 identified for the group of recipients 114 may be for one or more of group of recipients 114. Information 116 identified by notifier 118 is presented to sender 108 using notification 120 while sender 108 composes message 112.

For example, notifier 118 identifies recipient 122 of the message 112 while message 112 is being composed. Recipient 122 is a member of the group of recipients 114. The identification of recipient 122 may be made any number of different ways. For example, recipient 122 may be identified from an email address entered by sender 108, the selection of recipient 122 from a list of recipients 114, or using other suitable mechanisms.

Notifier 118 determines whether information 116 for use in composing message 112 is present about recipient 122. In this illustrative example, notification 120 is presented to sender 108 based on information 116 about recipient 122 while message 112 is being composed when information 116 about recipient 122 is present for message 112. In this particular example, the composing of message 112 does not end until message 112 is sent.

In this illustrative example, notification 120 may take various forms. For example, notification 120 may be at least one of a visual notification or an audio notification. For example, notification 120 may be displayed by data processing system 104 or audibly presented using speakers in data processing system 104. The visual form of notification 120 may be selected from one of a pop up window, tooltip, or some other suitable form. The audio form of notification 120 may be information 116 being presented using a text to speech system. Notification 120 may be presented during different times during the composition of message 112. For example, notification 120 may be displayed in response to a selection of recipient 122, validation of message 112, as content is entered into message 112, or at some other suitable time while message 112 is being composed.

In this illustrative example, a tool tip is a pop up window displayed when a user moves a mouse over a portion of message 112 that has been emphasized. For example, the emphasized portion of message 112 may be a keyword in message 112 that matches information 116 about recipient 122. As another example, recipient 122 may also be emphasized.

As used herein, emphasizing text is changing how the text is presented to highlight the text in comparison with the rest of the message. For example, emphasizing text may include at least one of changing font type, changing font color, changing whether the text is underlined, changing whether the text is bolded, changing whether the text is italicized, or other suitable ways to change how the text in being presented in comparison with the rest of message 112.

Validation of message 112 may occur when message 112 is checked to see if message 112 is ready to send. For example, notifier 118 may determine whether information 116 is present for recipients 114 based on a group of attributes of message 112. This group of attributes may include, for example, an identification of sender 108, an identification of recipient 122, content of message 112, whether an attachment is present for message 112, size, type, and description of attachments in message 112, or some other suitable property about message 112. For example, the validation may include determining whether the subject line has been filled out, whether an attachment is present when the attachment is mentioned in the body of message 112, whether addresses for the group of recipients 114 are valid, or based on other parameters of message 112 that may be performed.

As depicted, information 116 may be identified by notifier 118 using data structure 124 in the form of database 126. In other illustrative examples, data structure may 124 take other forms in other illustrative examples. For example, data structure 124 also may be a flat file, a linked list, a spreadsheet, or other suitable forms.

In this illustrative example, information 116 in database 126 is based on the relationship between sender 108 and recipient 122. In other words, information 116 about recipient 122 is generated by sender 108 from what sender 108 knows about recipient 122. Information 116 may be undisclosed information that is not generally known by others. Information 116 is not published or generally made available by recipient 122 in this illustrative example. Also, information 116 in database 126 is generated by sender 108 in this illustrative example.

The relationship may take different forms. For example, the relationship may be a non-professional relationship, a work relationship, a professional relationship, or some other type of relationship through which sender 108 is able to identify information 116 about recipient 122 for use in generating message 112. For example, sender 108 may be a friend of recipient 122. Sender 108 and recipient 122 may be coworkers, sender 108 may be a manager of recipient 122, or some other work or professional relationship may be present.

In this manner, sender 108 may be able to select recipients 114 for the group of recipients 114 to receive message 112 based on information 116. For example, if recipient 122 has a tendency not to attend videoconferences, sender 108 may not select recipient 122 when message 112 is a calendar invite for a videoconference. As a result, notifier 118 may aid sender 108 in composing message 112. For example, notifier 118, due to use of notification 120, may help sender 108 in generating a list of the group of recipients 114 for message 112.

Turning next to FIG. 2, an illustration of a block diagram of an example of information in a database is depicted in accordance with an illustrative embodiment. In this illustrative example, entry 200 is an example of an entry that is present in database 126 in FIG. 1.

As depicted, entry 200 has a number of different fields. In this illustrative example, the fields include recipient identifier 202 and information 204.

As depicted, recipient identifier 202 includes include name 206 and email address 208. Name 206 is the name of recipient 122. Name 206 may be a formal name of recipient 122, a nickname of recipient 122, or some combination thereof. Email address 208 includes one or more email addresses used by recipient 122.

In this illustrative example, information 204 includes a number of different types of information. As depicted, information 204 may include attachment warning 210, co-worker warning 212, and attendance warning 214. Information 204 is an example of information 116 in FIG. 1.

Attachment warning 210 is information that indicates whether recipient 122 may have trouble receiving attachments generally, attachments exceeding a selected size, or other information about the attachments. Co-worker warning 212 is information that indicates whether others in recipients 114 should not be included in message 112. Attendance warning 214 may indicate whether recipient 122 is typically late, a no-show, or some other information about the attendance of recipient 122.

With reference now to FIG. 3, an illustration of a block diagram of another example of information in a database is depicted in accordance with the illustrative embodiment. In this depicted example, entry 300 is another example of an entry that may be present in database 126 in FIG. 1.

As depicted, entry 300 has a number of different fields. In this illustrative example, keywords 302 and recipient identifiers 304 are present in entry 300.

Keywords 302 indicate the presence sensitive information in the content of message 112 if keywords 302 are present in message 112. For example, keywords 302 may include words or phrases that may be used to indicate that confidential information may be present in message 112. In other illustrative examples, keywords 302 may be the confidential information that should not be disclosed. For example, keywords 302 may be the name of an internal project or product that is not yet publicly available. In other illustrative examples, keywords 302 may not be the actual sensitive information but may indicate that sensitive information may be present in the content of message 112.

In this illustrative example, recipient identifiers 304 are examples of possible recipients for message 112. For example, group of recipients 114 may include one or more of recipient identifiers 304. As depicted, recipient identifiers 304 are content rules indicating that keywords 302 are sensitive information for recipient identifiers 304. For example, when one or more of recipient identifiers 304 match one or more of group of recipients 114, keywords 302 matching the content of message 112 indicate notification 120 should be presented.

In this manner, sender 108 may compose message 112 in a desired manner. For example, sender 108 may change the group of recipients 114, whether attachments are included, monitoring the size of attachments, change the content of message 112, or perform other steps in composing message 112.

The illustration of messaging environment 100 and the different components in FIGS. 1-3 is not meant to imply physical or architectural limitations to the manner in which an illustrative embodiment may be implemented. Other components in addition to or in place of the ones illustrated may be used. Some components may be unnecessary. Also, the blocks are presented to illustrate some functional components. One or more of these blocks may be combined, divided, or combined and divided into different blocks when implemented in an illustrative embodiment.

For example, at least one of notifier 118 or database 126 may be located in a location remote to data processing system 104 depending on the particular implementation. In other words, notifier 118, database 126, or both may be located on another piece of hardware other than data processing system 104. Also, although notifier 118 is shown as a component of data processing system 104, notifier 118 may be implemented as a separate component from data processing system 104, integrated with message application 110, or some other suitable form. In other illustrative examples, notifier 118 and database 126 also may be located on a server computer in a remote location to data processing system 104. With this type of implementation, notifier 118 may be provided as a service to sender 108 by a third party.

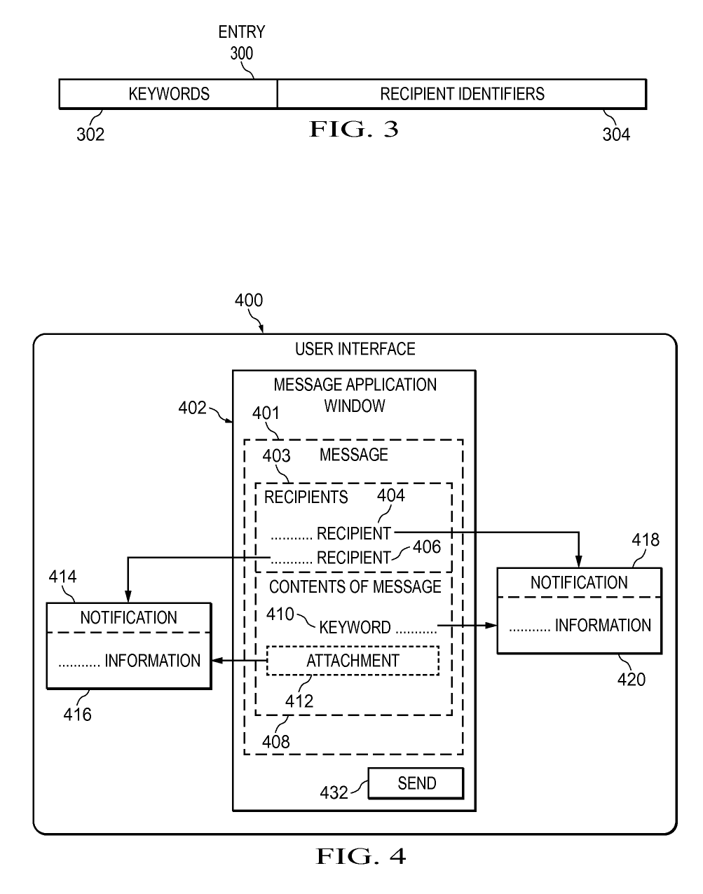

With reference now to FIG. 4, an illustration of a block diagram of a user interface for a message application is depicted in accordance with an illustrative embodiment. User interface 400 is an illustrative example of one implementation of graphical user interface 111 in FIG. 1. In other illustrative examples, user interface 400 may also be any type of user interface suitable for presenting the contents of user interface 400 to one or more users.

In this illustrative example, user interface 400 includes message application window 402 for composing messages. As depicted, message 401 in FIG. 4 is an example of message 112 in FIG. 1. In this illustrated example, message 401 is being composed in message application window 402. Recipients 403 in message 401 are an example of a group of recipients 114 in FIG. 1. Recipient 404 and recipient 406 in recipients 403 are examples of recipient 122 in FIG. 1.

In the illustrative example, message 401 includes content of message 408. As depicted, content of message 408 includes keyword 410 and attachment 412. Keyword 410 is an example of a keyword in keywords 302 in FIG. 3.

Notification 414 in user interface 400 is a pop up window that includes information 416 about recipient 406 for use in composing message 401. In this illustrative example, responsive to a user adding recipient 406 to recipients 403 and attachment 412 to content of message 408, a process identifies a content rule for recipient 406 to show notification 414 based on a particular attribute of attachment 412. In this example, recipient 406 is an example of email address 208 in FIG. 2 and the content rule for recipient 406 is an example of attachment warning 210 in FIG. 2.

Notification 418 in user interface 400 is a pop up window that includes information 420 about recipient 404 for use in composing message 401. In this illustrative example, responsive to a user adding recipient 404 to recipients 403 and keyword 410 to content of message 408, a process identifies a content rule for recipient 404 to show notification 418 based on keyword 410 matching at least one keyword previously selected for recipient 404. In this example, recipient 404 is an example of a recipient in recipient identifiers 304 in FIG. 3 and keyword 410 is an example of a keyword in keywords 302 in FIG. 3.

Send 432 is a button in message application window 402 to initiate a process for sending message 401 to recipients 403. The process for sending message 401 to recipients 403 may include, for example, first generating notification 414 and notification 418 before sending the message to recipients 403. In this example, the process for sending message 401 may first require a user to dismiss one or both of notification 414 and notification 418.

In these illustrative examples, a user may dismiss a notification by selecting the notification or by providing some other type of user input that results in the notification no longer being valid. In this illustrated example, when a user removes one of recipient 404 or keyword 410 from message 401, notification 418 will no longer be displayed on user interface 400 for message 401.

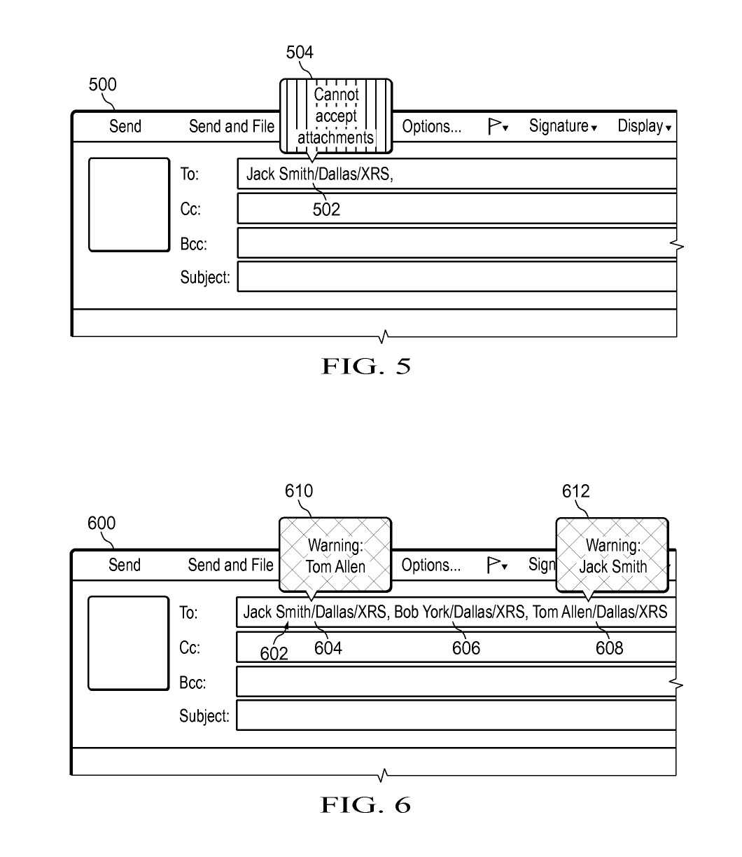

With reference next to FIG. 5, an illustration of an example of a notification to a sender for a recipient of a message is depicted in accordance with an illustrative embodiment. Message window 500 is an illustrative example of one implementation of graphical user interface 111 in FIG. 1.

In this illustrative example, message window 500 includes notification 504 for recipient 502. As depicted, recipient 502 is an example of recipient 122 in FIG. 1.

Notification 504 includes information about recipient 502 for use in composing a message in message window 500. For example, responsive to a user composing a message in message window 500 that includes an attachment, a process for generating notifications determines whether information is present for recipient 502 for composing the message. In this illustrated example, the information present for recipient 502 is an example of attachment warning 210 in FIG. 2 that recipient 502 cannot accept attachments.

As depicted, notification 504 may include use of a graphical indicator to emphasize the presence of notification 504. The graphical indicator may also be used to convey importance or other information. As used herein, a graphical indicator used to emphasize of a notification may include use of at least one of font type, font color, background color, blinking colors, animation, a particular icon or other type of image, flashing text, or other suitable ways to highlight the notification in comparison with other notifications. For example, the graphical indicator for notification 504 may include use of a color to indicate that notification 504 is a warning.

With reference next to FIG. 6, an illustration of an example of notifications to a sender for recipients of a message is depicted in accordance with an illustrative embodiment. Message window 600 is an illustrative example of one implementation of graphical user interface 111 for message application 110 in data processing system 104 in FIG. 1. As depicted, recipients 602 are an example of a group of recipients 114 in FIG. 1. Recipient 604, recipient 606, and recipient 608 are examples of recipient 122 in FIG. 1.

In this illustrative example, message window 600 includes notification 610 for recipient 604. Notification 610 includes information about recipient 604 for use in composing a message in message window 600. Notification 612 includes information about recipient 608 for use in composing the message in message window 600. For example, responsive to a user selecting recipient 604 and recipient 608 for recipients 602, a process for generating notifications determines whether information is present for recipient 604 and recipient 608 for composing the message. In this illustrated example, the information present for recipient 604 and recipient 608 are examples of co-worker warning 212 in FIG. 2.

As depicted, notification 610 and notification 612 may include use of emphasis. For example, the graphical indicator used for notification 610 and notification 612 may be a use of a unique color for both notification 610 and notification 612 to indicate that notification 610 and notification 612 are both co-worker warnings.

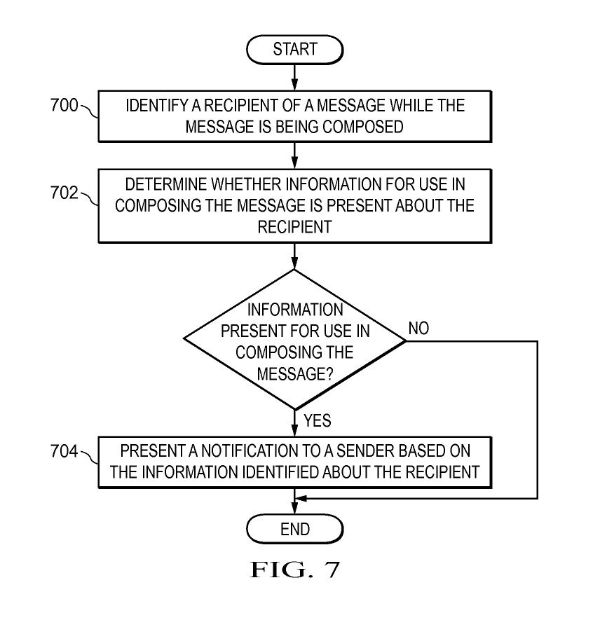

With reference next to FIG. 7, an illustration of a flowchart process for generating a notification about a recipient of a message is depicted in accordance with an illustrative embodiment. The process illustrated in FIG. 7 may be implemented in messaging environment 100 in FIG. 1. In particular, the process illustrated in this figure may be implemented in notifier 118.

The process begins by identifying a recipient of a message while the message is being composed (step 700). Next, a determination is made as to whether information for use in composing the message is present about the recipient (step 702). The information in step 702 is based on a relationship between a sender of the message and the recipient. In other words, the sender identifies information from dealings or interactions with the recipient. The sender saves this information for use in composing messages to obtain notifications when the particular recipient is selected to receive a message. A determination is made based on the recipient, the recipient and other recipients, content in the message, and other suitable types of information about the recipient.

If information is present, the process presents a notification to a sender based on the information identified about the recipient while the message is being composed (step 704), with the process terminating thereafter. In the illustrative example, the notification may be at least one of a visual notification or an audio notification. For example, the information may be displayed on a display device in a data processing system being used by the sender. In another illustrative example, information may be given audibly over a speaker system. The audible presentation information may be made using a text to speech process. The speaker system may be a speaker system in the data processing system or in communication with the data processing system. The speaker system in communication with the data processing system may be, for example, a wireless headset or some other suitable device.

With reference again to step 702, if information is not present about the recipient, the process also terminates. This process may be performed any number of times in response to some event. For example, the event may be the selection of the recipient, a validation of the message prior to sending the message, or some other suitable event. Further, the event may be based on a periodic timer in which the process runs each time the timer expires.

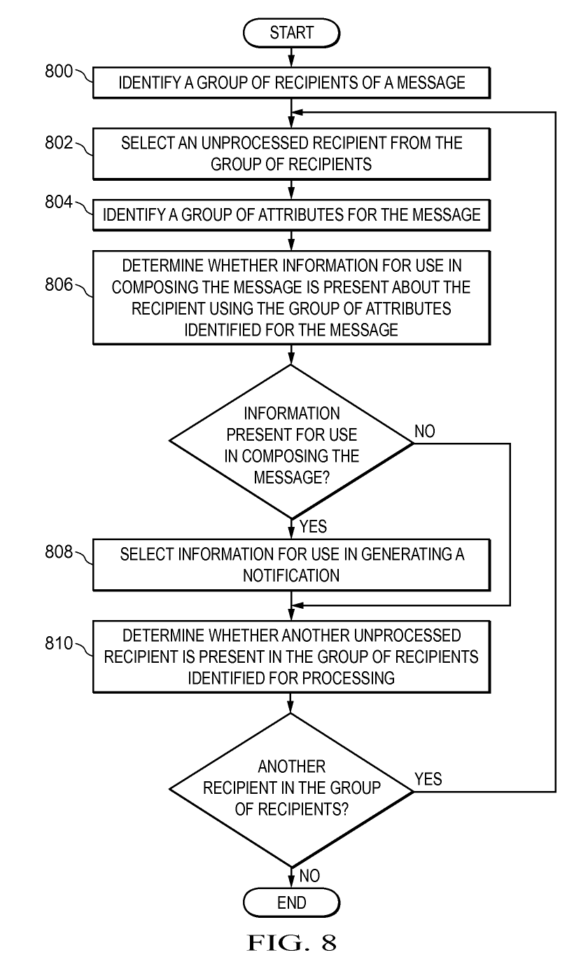

Turning next to FIG. 8, an illustration of a flowchart of a process for determining whether information is present about a recipient of a message for use in composing the message is depicted in accordance with an illustrative embodiment. The process illustrated in FIG. 8 is an example of an implementation for step 702 in FIG. 7.

The process begins by identifying a group of recipients of a message (step 800). The process then selects an unprocessed recipient from the group of recipients (step 802).

The process then identifies a group of attributes for the message (step 804). These attributes are properties of the message. For example, an attribute may be selected from one of a sender, recipients, a presence of attachments, the particular words in the message, particular images in the message, whether a subject line has been filled out, a length of the message, sizes of the attachments, types of the attachments, descriptions of the attachments, and other suitable information about the message. In these illustrative examples, the information is based on the relationship between a sender and the recipient of the message.

The process then determines whether information for use in composing the message is present about the recipient using the group of attributes identified for the message (step 806). If information is present, the process then selects information for use in generating a notification (step 808).

Thereafter, a determination is made as to whether another unprocessed recipient is present in the group of recipients identified for processing (step 810). If another recipient is present, the process then returns to step 802. Otherwise, the process terminates. The process also proceeds to step 810 from step 806, if information is not present for the recipient.

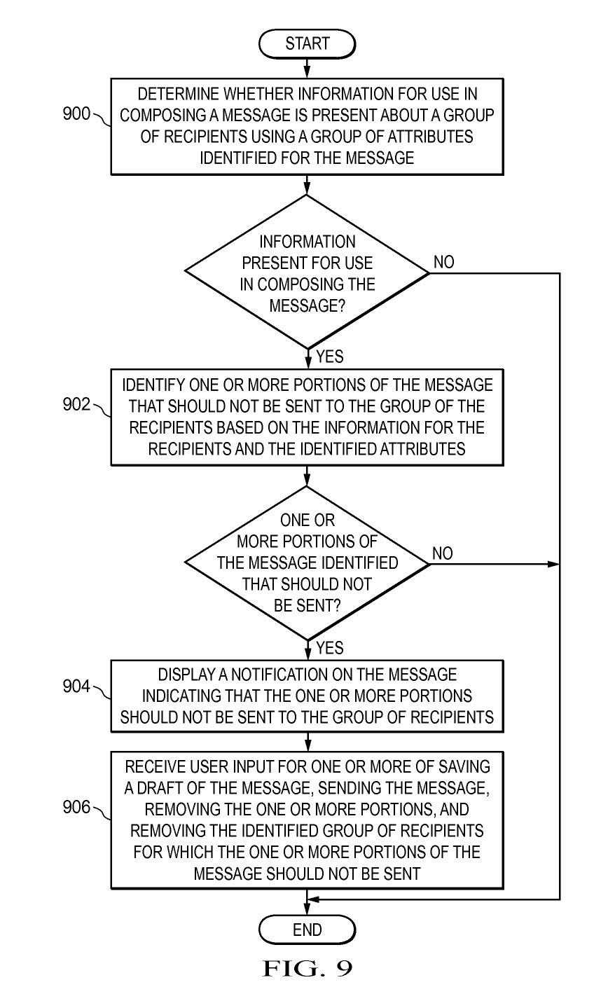

Turning now to FIG. 9, an illustration of a flowchart of a process for managing messages is depicted in accordance with an illustrative embodiment. The process illustrated in FIG. 9 may be implemented in messaging environment 100 in FIG. 1. In particular, the process illustrated in this figure may be implemented in notifier 118.

The process begins by determining whether information for use in composing a message is present about a group of recipients using a group of attributes identified for the message (step 900). The group of recipients in this process is an example of recipients 114 in FIG. 1. The information in this process is an example of information 116 in FIG. 1. The message is an example of message 112 in FIG. 1. For example, information 116 for recipients 114 of message 112 may identify a portion of message 112 that should not be sent to recipients 114.

When information is not present for use in composing the message, the process terminates. Otherwise when information is present for use in composing the message, the process then identifies one or more portions of the message that should not be sent to the group of recipients based on the information for the recipients and the identified attributes (step 902).

As depicted, if no portions of the message are identified that should not be sent, the process terminates. Otherwise, when one or more portions of the message are identified that should not be sent, the process next displays a notification on the message indicating that the one or more portions should not be sent to the group of recipients (step 904). The process then receives user input for one or more of saving a draft of the message, sending the message, removing the one or more portions, and removing the identified group of recipients for which the one or more portions of the message should not be sent (step 906), with the process terminating thereafter.

This process may be performed any number of times in response to some event. For example, the event may be the selection of the recipient, a validation of the message prior to sending message, or some other suitable event. Further, the event may be based on a periodic timer in which the processes runs each time the timer expires.

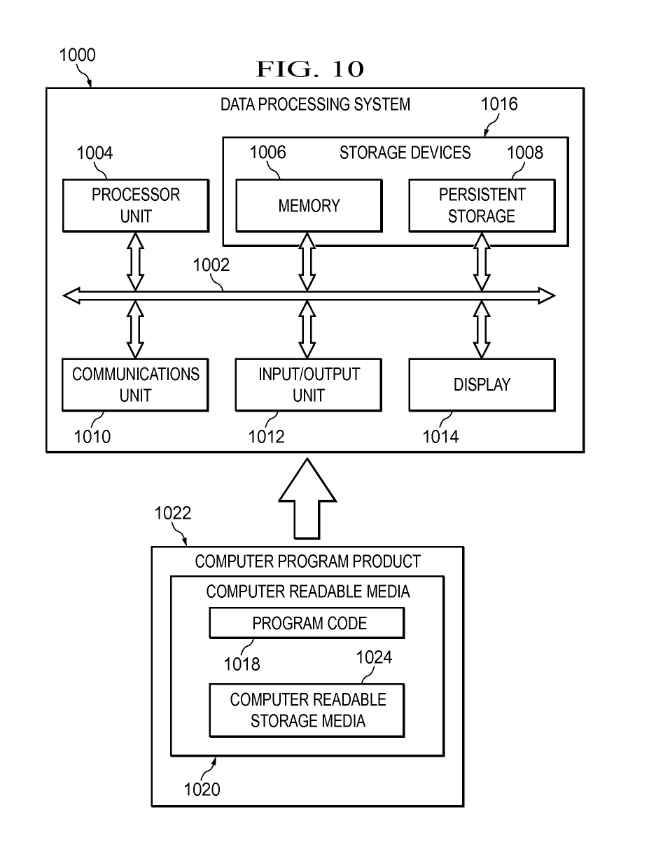

Turning now to FIG. 10, an illustration of a block diagram of a data processing system is depicted in accordance with an illustrative embodiment. Data processing system 1000 is an example of a data processing system that may be used to implement data processing system 104 and data processing systems 106 in FIG. 1. In this illustrative example, data processing system 1000 includes communications framework 1002, which provides communications between processor unit 1004, memory 1006, persistent storage 1008, communications unit 1010, input/output (I/O) unit 1012, and display 1014. In these examples, communications framework 1002 may be a bus system.

Processor unit 1004 serves to execute instructions for software that may be loaded into memory 1006. Processor unit 1004 may be a number of processors, a multi-processor core, or some other type of processor, depending on the particular implementation. A number, as used herein with reference to an item, means one or more items. Further, processor unit 1004 may be implemented using a number of heterogeneous processor systems in which a main processor is present with secondary processors on a single chip. As another illustrative example, processor unit 1004 may be a symmetric multi-processor system containing multiple processors of the same type. A group of processors or processor units is one of more processors that may be located on a same computer or on different computers. In other words, the group of processors could be distributed in different locations.

Memory 1006 and persistent storage 1008 are examples of storage devices 1016. A storage device is any piece of hardware that is capable of storing information, such as, for example, without limitation, data, program code in functional form, and/or other suitable information either on a temporary basis and/or a permanent basis. Storage devices 1016 may also be referred to as computer readable storage devices in these examples. Memory 1006, in these examples, may be, for example, a random access memory or any other suitable volatile or non-volatile storage device. Persistent storage 1008 may take various forms, depending on the particular implementation.

For example, persistent storage 1008 may contain one or more components or devices. For example, persistent storage 1008 may be a hard drive, a flash memory, a rewritable optical disk, a rewritable magnetic tape, or some combination of the above. The media used by persistent storage 1008 also may be removable. For example, a removable hard drive may be used for persistent storage 1008.

Communications unit 1010, in these examples, provides for communications with other data processing systems or devices. In these examples, communications unit 1010 is a network interface card. Communications unit 1010 may provide communications through the use of either or both physical and wireless communications links.

Input/output unit 1012 allows for input and output of data with other devices that may be connected to data processing system 1000. For example, input/output unit 1012 may provide a connection for user input through a keyboard, a mouse, and/or some other suitable input device. Further, input/output unit 1012 may send output to a printer. Display 1014 provides a mechanism to display information to a user.

Instructions for the operating system, applications, and/or programs may be located in storage devices 1016, which are in communication with processor unit 1004 through communications framework 1002. In these illustrative examples, the instructions are in a functional form on persistent storage 1008. These instructions may be loaded into memory 1006 for execution by processor unit 1004. The processes of the different embodiments may be performed by processor unit 1004 using computer implemented instructions, which may be located in a memory, such as memory 1006.

These instructions are referred to as program code, computer usable program code, or computer readable program code that may be read and executed by a processor in processor unit 1004. The program code in the different embodiments may be embodied on different physical or computer readable storage media, such as memory 1006 or persistent storage 1008.

Program code 1018 is located in a functional form on computer readable media 1020 that is selectively removable and may be loaded onto or transferred to data processing system 1000 for execution by processor unit 1004. Program code 1018 and computer readable media 1020 form computer program product 1022 in these examples. In one example, computer readable media 1020 may be computer readable storage media 1024. Computer readable storage media 1024 may include, for example, an optical or magnetic disk that is inserted or placed into a drive or other device that is part of persistent storage 1008 for transfer onto a storage device, such as a hard drive, that is part of persistent storage 1008. Computer readable storage media 1024 also may take the form of a persistent storage, such as a hard drive, a thumb drive, or a flash memory, that is connected to data processing system 1000. In some instances, computer readable storage media 1024 may not be removable from data processing system 1000. In these examples, computer readable storage media 1024 is a physical or tangible storage device used to store program code 1018 rather than a medium that propagates or transmits program code 1018. Computer readable storage media 1024 is also referred to as a computer readable tangible storage device or a computer readable physical storage device. In other words, computer readable storage media 1024 is a media that can be touched by a person.

The different components illustrated for data processing system 1000 are not meant to provide architectural limitations to the manner in which different embodiments may be implemented. The different illustrative embodiments may be implemented in a data processing system including components in addition to or in place of those illustrated for data processing system 1000. Other components shown in FIG. 10 can be varied from the illustrative examples shown. The different embodiments may be implemented using any hardware device or system capable of running program code. As one example, the data processing system may include organic components integrated with inorganic components and/or may be comprised entirely of organic components excluding a human being. For example, a storage device may be comprised of an organic semiconductor.

In another illustrative example, processor unit 1004 may take the form of a hardware unit that has circuits that are manufactured or configured for a particular use. This type of hardware may perform operations without needing program code to be loaded into a memory from a storage device to be configured to perform the operations. For example, when processor unit 1004 takes the form of a hardware unit, processor unit 1004 may be a circuit system, an application specific integrated circuit (ASIC), a programmable logic device, or some other suitable type of hardware configured to perform a number of operations. With a programmable logic device, the device is configured to perform the number of operations. The device may be reconfigured at a later time or may be permanently configured to perform the number of operations. Examples of programmable logic devices include, for example, a programmable logic array, a programmable array logic, a field programmable logic array, a field programmable gate array, and other suitable hardware devices. With this type of implementation, program code 1018 may be omitted because the processes for the different embodiments are implemented in a hardware unit.

In still another illustrative example, processor unit 1004 may be implemented using a combination of processors found in computers and hardware units. Processor unit 1004 may have a number of hardware units and a number of processors that are configured to run program code 1018. With this depicted example, some of the processes may be implemented in the number of hardware units, while other processes may be implemented in the number of processors.

In another example, a bus system may be used to implement communications framework 1002 and may be comprised of one or more buses, such as a system bus or an input/output bus. Of course, the bus system may be implemented using any suitable type of architecture that provides for a transfer of data between different components or devices attached to the bus system.

Additionally, a communications unit may include a number of more devices that transmit data, receive data, or transmit and receive data. A communications unit may be, for example, a modem or a network adapter, two network adapters, or some combination thereof. Further, a memory may be, for example, memory 1006, or a cache, such as found in an interface and memory controller hub that may be present in communications framework 1002.

The flowcharts and block diagrams in the different depicted embodiments illustrate the architecture, functionality, and operation of some possible implementations of apparatus, methods and computer program products. In this regard, each block in the flowcharts or block diagrams may represent a module, segment, or portion of computer usable or readable program code, which comprises one or more executable instructions for implementing the specified function or functions. In some alternative implementations, the function or functions noted in the block may occur out of the order noted in the figures. For example, in some cases, two blocks shown in succession may be executed substantially concurrently, or the blocks may sometimes be executed in the reverse order, depending upon the functionality involved.

Thus, the illustrative examples provide a method and apparatus for generating notifications about recipients that may receive a message. In the illustrative examples, the notification may aid a sender in selecting recipients for message. Additionally, the illustrative examples may also aid the sender in composing the message as well as determining what if any attachments should be used.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiment. The terminology used herein was chosen to best explain the principles of the embodiment, the practical application or technical improvement over technologies found in the marketplace, or to enable others of ordinary skill in the art to understand the embodiments disclosed here.

The flowcharts and block diagrams in the Figures illustrate the architecture, functionality, and operation of possible implementations of systems, methods and computer program products according to various embodiments of the present invention. In this regard, each block in the flowcharts or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, can be implemented by special purpose hardware-based systems that perform the specified functions or acts, or combinations of special purpose hardware and computer instructions.

What is claimed is:

1. A method for generating a notification about a recipient of a message, the method comprising:
identifying the recipient of the message while the message is being composed;
determining whether information is present about the recipient for use in composing the message; and
presenting the notification to a sender based on the information identified about the recipient while the message is being composed when the information about the recipient is present for the message.

2. The method of claim 1, wherein the determining step comprises:
determining whether the information for use in composing the message is present in a database.

3. The method of claim 1, wherein the determining step comprises:
determining whether the information for use in composing the message is present about the recipient based on content currently present in the message and keywords in the information about the recipient.

4. The method of claim 1, wherein the presenting step comprises:
presenting the information about the recipient on the message prior to the message being sent to the recipient using at least one of a visual notification or an audio notification.

5. The method of claim 1, wherein the presenting step comprises:
displaying the notification as information in one of a pop up window and a tool tip.

6. The method of claim 1, wherein the presenting step is performed in response to an event selected from one of a selection of the recipient and a validation of the message.

7. The method of claim 1, wherein the message is selected from one of an email message and a meeting invite.

8. The method of claim 1, wherein the information about the recipient includes a relationship between the sender and the recipient, and wherein the relationship is selected from one of a non-professional relationship, a professional relationship, and a work relationship.

9. A data processing system comprising:
a memory with a program code located in the memory;
a processor unit in communication with the memory, wherein the processor unit runs the program code to identify a recipient of a message while the message is being composed; determine whether information is present about the recipient for use in composing the message; and present a notification about the recipient to a sender based on the information identified about the recipient while the message is being composed when the information about the recipient is present for the message.

10. The data processing system of claim 9, wherein the program code that is run to determine whether the information is present about the recipient for use in composing the message comprises program code that is run to determine whether the information for use in composing the message is present in a database.

11. The data processing system of claim 9, wherein the program code that is run to determine whether the information is present about the recipient for use in composing the message comprises program code that is run to determine whether the information for use in composing the message is present about the recipient based on content currently present in the message and keywords in the information about the recipient.

12. The data processing system of claim 9, wherein the program code that is run to present the notification about the recipient to the sender based on the information identified about the recipient while the message is being composed when the information about the recipient is present for the message comprises program code that is run to present the information about the recipient on the message prior to the message being sent to the recipient using at least one of a visual notification or an audio notification.

13. The data processing system of claim 9, wherein the program code that is run to present the notification about the recipient to the sender based on the information identified about the recipient while the message is being composed when the information about the recipient is present for the message comprises program code that is run to display the notification as information in one of a pop up window and a tool tip.

14. The data processing system of claim 9, wherein the program code that is run to present the notification about the recipient to the sender based on the information identified about the recipient while the message is being composed when the information about the recipient is present for the message is further responsive to an event selected from one of a selection of the recipient and a validation of the message.

15. A computer program product comprising:
computer readable storage media;
first program code, stored on the computer readable storage media, for identifying a recipient of a message while the message is being composed;
second program code, stored on the computer readable storage media, for determining whether information is present about the recipient for use in composing the message; and
third program code, stored on the computer readable storage media, for presenting a notification about the recipient to a sender based on the information identified about the recipient while the message is being composed when the information about the recipient is present for the message.

16. The computer program product of claim 15, wherein the second program code for determining whether the information is present about the recipient for use in composing the message comprises program code for determining whether the information for use in composing the message is present in a database.

17. The computer program product of claim 15, wherein the second program code for determining whether the information is present about the recipient for use in composing the message comprises program code for determining whether the information for use in composing the message is present about the recipient based on content currently present in the message and keywords in the information about the recipient.

18. The computer program product of claim 15, wherein the third program code for presenting the notification about the recipient to the sender comprises program code for presenting the information about the recipient on the message prior to the message being sent to the recipient using at least one of a visual notification or an audio notification.

19. The computer program product of claim 15, wherein the third program code for presenting the notification about the recipient to the sender comprises program code for displaying the notification as information in one of a pop up window and a tool tip.

20. The computer program product of claim 15, wherein the third program code for presenting the notification about the recipient to the sender based on the information identified about the recipient while the message is being composed when the information about the recipient is present for the message comprises program code for presenting the notification about the recipient to the sender is further responsive to an event selected from one of a selection of the recipient and a validation of the message.
